(19) United States
(12) Patent Application Publication
(10) Pub. No.: US 2012/0087769 A1
(43) Pub. Date: Apr. 12, 2012

(54) Apparatus for Sidewalk Removal and Transport

(76) Inventors: William B. Michaels, Monee, IL (US); Patrick A. Burnett, Crete, IL (US)

(21) Appl. No.: 12/902,831

(22) Filed: Oct. 12, 2010

(51) Int. Cl. B66F 9/18

(52) U.S. Cl. 414/621

(57) ABSTRACT

An apparatus such as an attachment for a skid steer used to remove and transport sidewalk segments may include a plurality of translating forks configured to drive into the ground surrounding the segment. The apparatus also may include a plurality of bearing surfaces for contacting and applying an upwardly directed force to the underside of the segment. Each of the forks may be tapered to slide into the ground more easily, and each bearing surface may be removably attached to the apparatus for easy repair or replacement. By limiting the amount of the apparatus that penetrates the ground to the plurality of forks, the apparatus provides a method of removing sidewalk segments that is quick and efficient, resulting in minimal disturbance to the ground and easier preparation for pouring a new sidewalk segment.

### BACKGROUND OF THE INVENTION

1. Field of the Invention

The present invention is directed to an apparatus for removing and transporting portions of concrete or other paving, specifically for removing and transporting sections of sidewalk.

2. Description of the Related Art

Various methods for removing and transporting sections of sidewalk exist. One end of the spectrum involves jackhammering the section into smaller pieces and manually picking up and carrying the pieces to a second location such as a waste bin or a bin connected to a dump truck or semi. While this method may minimize the disturbance to the surrounding area, it is labor and time intensive, which may lead to decreased productivity and increased cost. In addition, this process may render the sidewalk sections unusable for many applications, since it may result in breaking the sections into several smaller pieces to better manage the weight.

Less manual methods also exist. For example, a small mechanized machine, including, e.g., a skid steer sold under the trademark BOBCAT, may be used with a bucket attachment to dig beneath the side edge of a concrete slab. Due to the weight of the skid steer, this process often results in substantial destruction of the landscaping surrounding the sidewalk and of the earthen foundation under the sidewalk. Particularly with soft soil, the wheels or tracks of a skid steer may create ruts in the parkway or other landscaped area as the skid steer moves toward and away from the sidewalk and adjusts position when attempting to remove the sidewalk portions. The bucket attachment also may significantly disturb the ground underneath the sidewalk, requiring substantial preparation and grading to ready the area for a new sidewalk.

Still another method of removing sidewalk portions may be to penetrate the ground under the sidewalk with one or more long forklift-type forks that can pivot relative to the ground. These forks may extend substantially along the length of the portion of sidewalk to be removed so that they provide significant lateral support underneath the portion. However, in order to penetrate far enough along the length of the portion, the forks often must be embedded deep into the soil underneath the portion. As they then are pivoted up towards the portion, they may disturb and remove a substantial portion of that foundation. In addition, the sidewalk portion may be relatively unstable when lifted to significant heights, such as when raising it over the edge of the bin connected to a semi.

What is needed is an apparatus that overcomes the drawbacks described above.

### BRIEF SUMMARY OF THE INVENTION

In one aspect, an apparatus for removing a sidewalk segment may comprise: a base portion including a plurality of rails; a plurality of forks translatable along the rails, each of the forks having a distal end that may taper; a hydraulic system controlling translation of the forks; and a plurality of bearing surfaces proximate the distal ends of the forks; wherein the plurality of forks extend substantially downward when inserted into ground surrounding the sidewalk segment; and wherein the bearing surfaces are substantially perpendicular to the forks. The base portion may include a flange and a bearing plate configured to releasably couple the apparatus to a skid steer.

The bearing surfaces may be releasably coupled to said plurality of forks. For example, the apparatus may have a plurality of holders proximate the distal ends of the forks, the plurality of holders configured to hold a plurality of wear bars, wherein the plurality of wear bars include the bearing surfaces. The wear bars may include at least one prong, and the holders may include at least one recess configured to receive the prong. In addition, each of the holders may taper in an opposite direction as the fork tapers.

In another aspect, an attachment for a skid steer may comprise: an attachment plate configured to couple to the skid steer; a plurality of rails coupled to the attachment plate; a plurality of forks coupled to a plurality of wheels, wherein the plurality of wheels translate along the rails; a plurality of bearing surfaces proximate distal ends of the forks; and at least one tapered tine proximate a distal end of each of the plurality of forks. The bearing surfaces may be removably coupled to the attachment, and the rails may include a plurality of inwardly-extending stops configured to limit translation of the wheels. The attachment also may include an adjustable depth limiter and a hydraulic system coupled to the forks, wherein the hydraulic system controls translation of the forks. The hydraulic system may include both a main line and a crossover line, the main line controlling translation of one of the forks, and the crossover line controlling translation of a second fork.

The attachment also may include a first cover coupled to one fork between the distal end of the fork and the hydraulic system and a second cover coupled to a second fork between the distal end of the second fork and the hydraulic system. In addition, the covers may overlap one another to provide coverage substantially across a distance between the forks.

In still another aspect, an apparatus for removing a sidewalk segment may comprise: a plurality of translatable forks, each fork including a proximal end and a tapered, distal end; a plurality of wear bars, each wear bar having a bearing surface, each surface substantially perpendicular to a respective fork; a plurality of wear bar holders proximate the distal ends of the respective forks; and a hydraulic ram coupled to at least one of the forks; wherein at least one wear bar includes a prong and at least one wear bar holder includes a recess configured to receive the prong. In addition, at least one wear bar holder may include at least one tine extending below the distal end of the fork, and the tine may taper from proximate the bearing surface toward a distal end of the tine.

The apparatus also may include a plurality of wheels coupled to the forks proximate the proximal end, and a plurality of rails configured to receive the wheels, wherein at least one rail includes a stop extending inward, the stop configured to restrain translation of at least one of the forks. The apparatus further may include a removable pin and the rails may include a plurality of openings configured to receive the pin, where the pin may be configured to restrain translation of at least one of said forks and to resist deformation caused by forces applied by the forks. Moreover, the apparatus may include a base portion configured to support the forks, the wear bars, the wear bar holders, and the hydraulic ram. The base portion may further be configured to translate in a direction substantially perpendicular to the sidewalk segment and to rotate about an axis substantially parallel to the sidewalk segment.

These and other features and advantages are evident from the following description of the present invention, with reference to the accompanying drawings.

### BRIEF DESCRIPTION OF THE SEVERAL VIEWS OF THE DRAWINGS

FIG. 1 is a perspective view of an apparatus for removing and transporting sections of sidewalk or other paving.

FIG. 2 is an exploded view of the apparatus of FIG. 1

FIG. 3 is a perspective view of the apparatus of FIG. 1, including a sidewalk section removed from the ground.

FIG. 4 is a perspective view of the apparatus of FIG. 1, attached to a skid steer, and shown in an elevated configuration for dumping a removed sidewalk section.

FIG. 5 is a side view of the apparatus of FIG. 1.

FIG. 6 is a side view of the other side of the apparatus of FIG. 1.

FIG. 7 is a front view of the apparatus of FIG. 1, illustrating one possible maximum open configuration in broken line.

FIG. 8 is a rear view of the apparatus of FIG. 1, illustrating one possible maximum open configuration in broken line.

FIG. 9 is a top view of the apparatus of FIG. 1, illustrating one possible maximum open configuration in broken line.

FIG. 10 is a bottom view of the apparatus of FIG. 1, illustrating one possible maximum open configuration in broken line.

### DETAILED DESCRIPTION

An apparatus 1 for removing and transporting sections of sidewalk or other paving may be an attachment to a skid steer, compact track loader, all-wheel steer loader or another type construction equipment, including e.g., a loader sold under the trademark BOBCAT or an excavator sold under the trademark GRADALL. Although the apparatus is described herein as an attachment for a skid steer 90, the apparatus may be modified to attach to these other types of equipment without diverging from the scope of the invention, such as by modifying attaching plate 2 to comply with the attachment requirements for that equipment. For the sake of description, apparatus 1 may be referred to herein as a “slabber.”

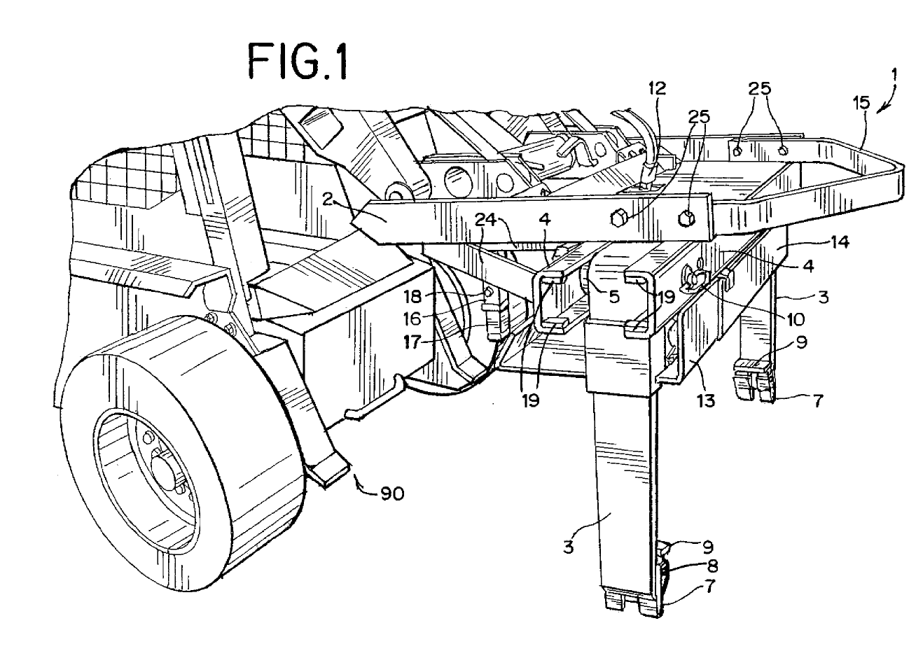

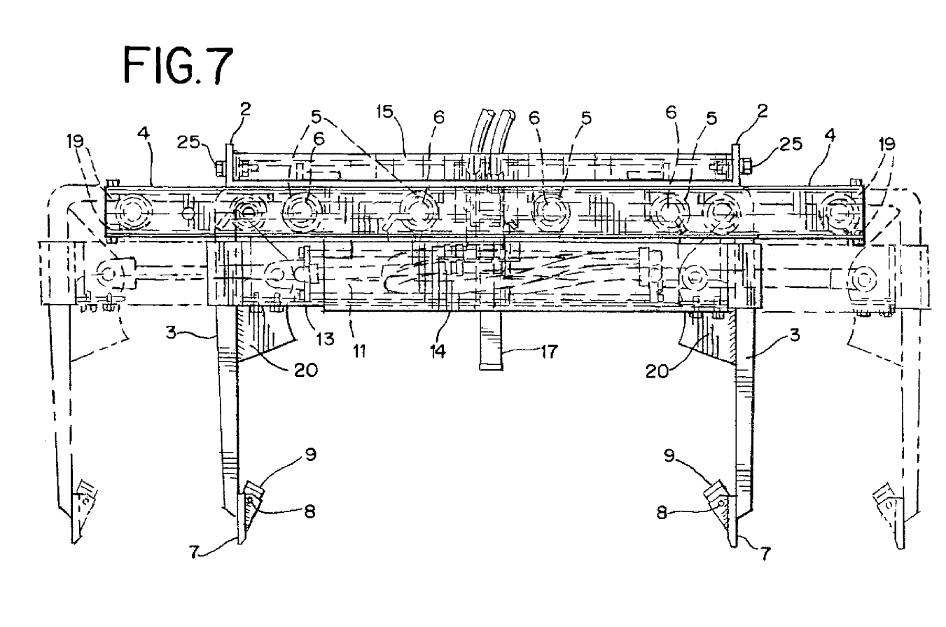

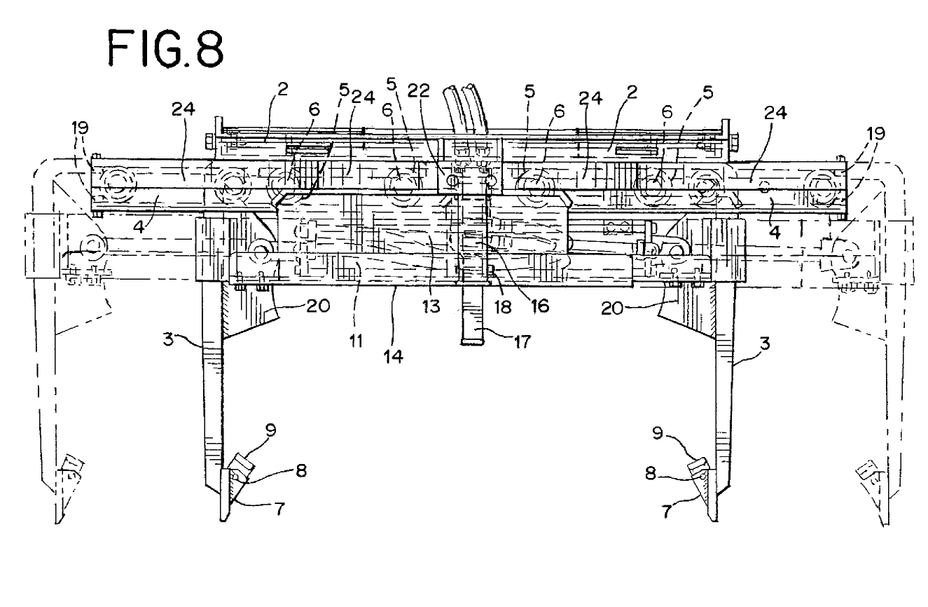

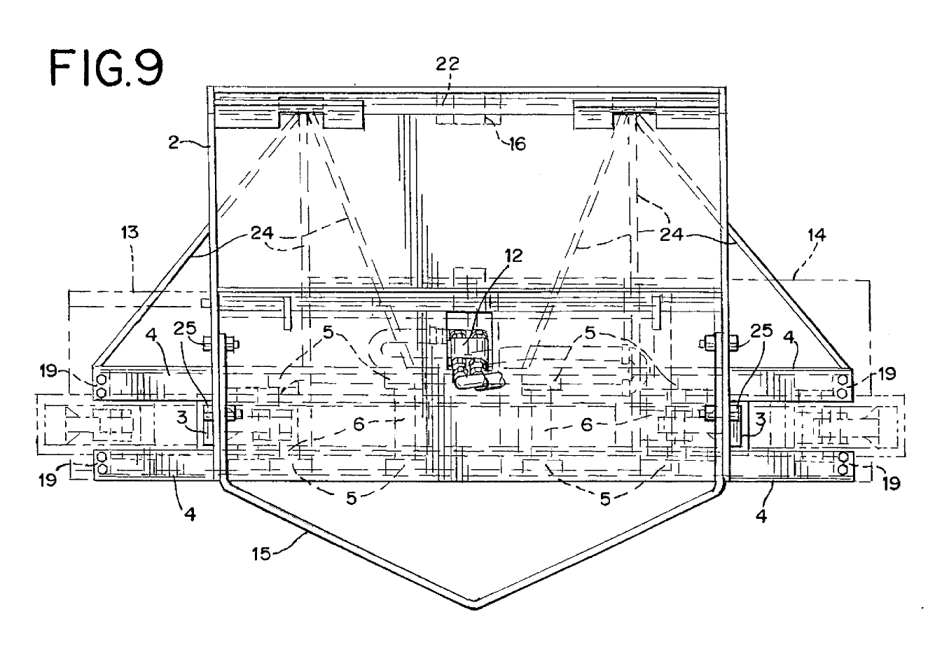

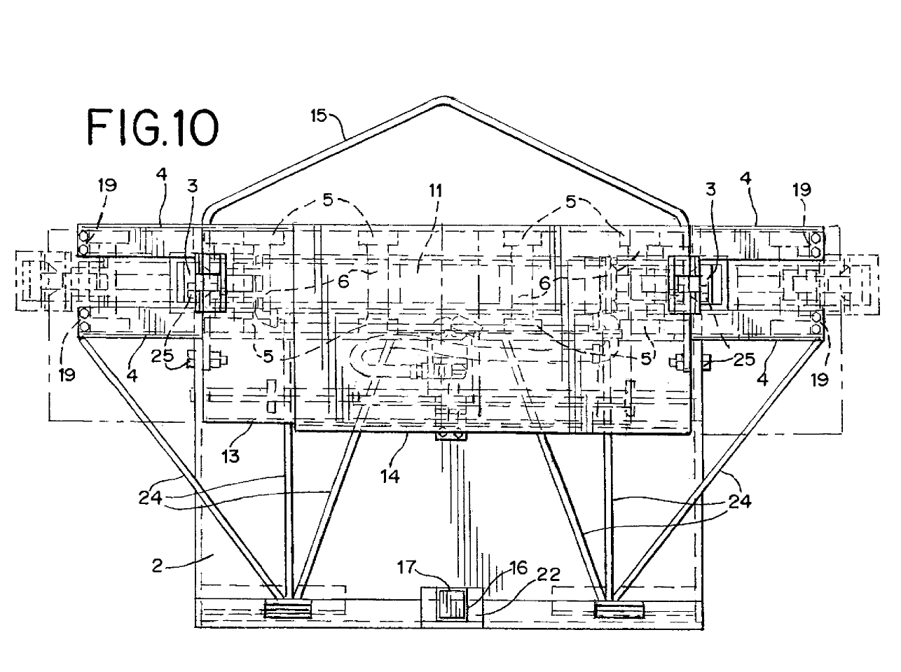

As seen in FIG. 1 and the various orthogonal views of FIGS. 7-10, skid steer 90 may include a plurality of prongs 92 and a locking mechanism 94. Attachment plate 2 may include a flange 34 disposed at substantially the same angle as prongs 92, so that prongs 92 may abut flange 34 when apparatus is mounted to skid steer 90. Plate 2 also may include bearing plate 36 for releasable engagement with locking mechanism 94. Bearing plate 36 may be inclined at substantially the same angle as flange 34 or, preferably, at an angle to maximize engagement with bearing plate 36. Attachment plate 2 may have a first side 40 and second side 42, with flange 34 extending substantially along a width of plate 2, from side 40 to side 42. Flange 34 may be attached to attachment plate 2, e.g., by welding to base of plate and to sides 40, 42. In addition, one or more braces 35 may be welded to attachment plate 2 and flange 34.

Slabber 1 may include a plurality of picking forks 3 traversable on a plurality of rails 4. Rails 4 may be supported by underside of attachment plate 2 and may extend laterally along a width of plate 2. Preferably, rails 4 extend beyond sides 40, 42 of attachment plate 2, allowing forks 3 to adjust over a longer range, thereby permitting slabber 1 to pick up sidewalk portions of larger, varying widths.

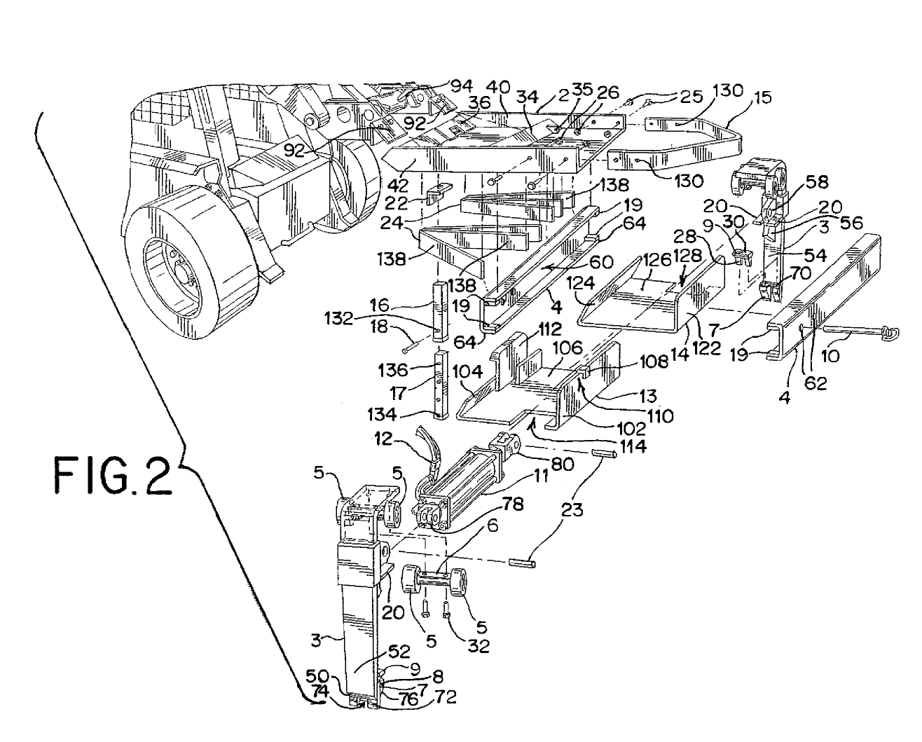

Forks 3 may traverse along rails 4 via one or more rollers 5 coupled to forks 3. As seen in FIG. 2, each fork 3 may be coupled to a plurality of roller shafts 6, e.g., via fasteners 32. Each roller shaft 6 may be operatively coupled to a plurality of rollers 5, preferably with at least one roller 5 on each end of shaft 6. Rollers 5 may be coupled to shaft 6 via bearings to facilitate rotation, e.g, via sealed bearings.

Each rail 4 may be generally C-shaped, forming channel 60, in order to provide rolling surfaces 66 for rollers 5, while keeping rollers 5 contained between sidewalls 68 of rails 4. One or both of rails 4 may include rolling stops 19 to limit traversal of rollers 5 and, as such, of forks 3. Rolling stops 19 may comprise tabs protruding inward from upper and lower portions 66 of rails 4, preferably proximate ends 64. As such, stops 19 may delineate a maximum possible extent that forks 3 may traverse laterally. In one embodiment, forks 3 may have a maximum separation between about 4 feet and about 8 feet, preferably about 6 feet.

Each rail 4 also may include one or more openings 62 spaced along rail sidewall 68. Slabber 1 may include a removable rod 10 adapted to pass through a respective pair of openings 62 in rails 4. Rod 10 may serve as another fork traversal limiter in one or more capacities. For example, one or more forks 3 may be located inward from rod 10. In this configuration, rod 10 may prevent fork 3 from extending laterally a distance beyond where rod 10 is placed. This configuration may be useful when transporting slabber 1 in order to keep forks 3 constrained in a storage configuration or when picking up smaller sidewalk sections where the full extent of traversal is not necessary. Rod 10 may be formed from a high strength material such as a high carbon steel in order to withstand force of forks pressing against rod 10 when a limit position is reached, thereby resisting deformation of rod 10, which may inhibit later removal of rod 10.

Alternatively, one or more forks 3 may be disposed between stops 19 and rod 10, in order to constrain traverse of forks 3 to a narrower range. By aligning openings 62 to comport with various standard sidewalk portion widths, e.g., to allow forks to close a distance slightly smaller than the sidewalk portion width, a pair of openings 62 corresponding to the appropriate width of the sidewalk portion being removed may be selected. As such, the slabber 1 may be constrained in the degree to which forks 3 may compress the sidewalk portion, which may allow forks 3 to close on the sidewalk portion but also prevent accidental crushing, cracking, or other breakage of the portion being removed.

Each fork 3 may have a laterally extending portion to which roller shafts 6 may be connected and a longer, downwardly extending portion that terminates at distal end 50. As seen in FIG. 2, roller shafts 6 may be connected to forks 3 via fasteners 32.

Distal end 50 may be tapered downward from outer face 52 to inner face 54 in order to form a blade-like surface for cutting through soil around sidewalk portion. Fork 3 also may include or be coupled to an inwardly extending wear bar holder 7. Holder 7 may include one or more downwardly extending tines 72. Returning to FIG. 1, each holder 7 may include a pair of tines 72 with a gap 74 therebetween. Like distal end 50 of fork 3, tines 72 may be tapered. Combined tapers of tines 72 and distal end 50 may provide fork 3 with a generally V-shaped wedge, which may reduce resistance and ease driving of forks 3 into the ground.

Holder 7 also may include one or more recesses 70. As seen in FIG. 2, recesses 70 may be generally aligned with, or may be formed within, tines 72. Slabber 1 may include a plurality of wear bars 9 on which sidewalk portion may rest during removal and transport. Wear bar 9 may include a plurality of prongs 28 configured to be inserted into recesses 70 of holder 7. In addition, holder 7 may include one or more openings, e.g., in side 76 of holder. Openings may be configured to receive wear bar pins 8 for removably coupling wear bar 9 to holder 7. In one embodiment, wear bar 9 also may include aligned openings such that pins 8 may pass through wear bar holder 7 and against or into wear bar 9. Pins 8 may be sized for frictional engagement with holder 7 and/or wear bar 9. Alternatively, pins 8 may be threaded, as may be one or more of holder 7 and wear bar 9.

Preferably, wear bar 9 may need replacement or repair significantly more frequently than forks 3. As such, pins 8 allow for easy removal and/or replacement of wear bars 9 without having to disassemble more of slabber 1.

Each wear bar 9 may include a bearing surface 30 on which a portion of the sidewalk segment may rest when the segment is removed from the ground. Bearing surface 30 also may allow for the transmission of a generally vertical force to separate sidewalk segment from foundation. Bearing surface 30 may be generally flat and may extend inward, substantially perpendicular to fork 3. Preferably, however, bearing surface 30 may be grooved, etched, or otherwise textured in order to increase surface area and frictional engagement with sidewalk segment. Bearing surface 30 may have a width substantially similar to width of fork 3, e.g., between about 4 inches and about 10 inches, preferably about 6 inches. Additionally, bearing surface 30 may extend inward between about 1 inch and about 8 inches, preferably between about 1 inch and about 4 inches, and in one embodiment, about 2 inches.

In the embodiment shown in FIG. 1, slabber 1 includes a pair of forks 3. Additional forks may be included to provide additional penetrating tines to aid in penetrating under the sidewalk segment and additional bearing surfaces for distributing and balancing the weight of the segment. Preferably, slabber 1 may include an even number of forks, generally equally distributed on either side of the segment, although slabber may include unequally distributed forks or one or more forks generally perpendicular to forks 3 for engaging a generally perpendicular side of the segment.

Forks 3 and holder 7 may be made of a strong, durable material such as high strength, high carbon steel. Added strength may allow forks 3 and holder 7 to drive through compacted soil, rocks, concrete fragments, etc. without cracking, breaking or deforming substantially.

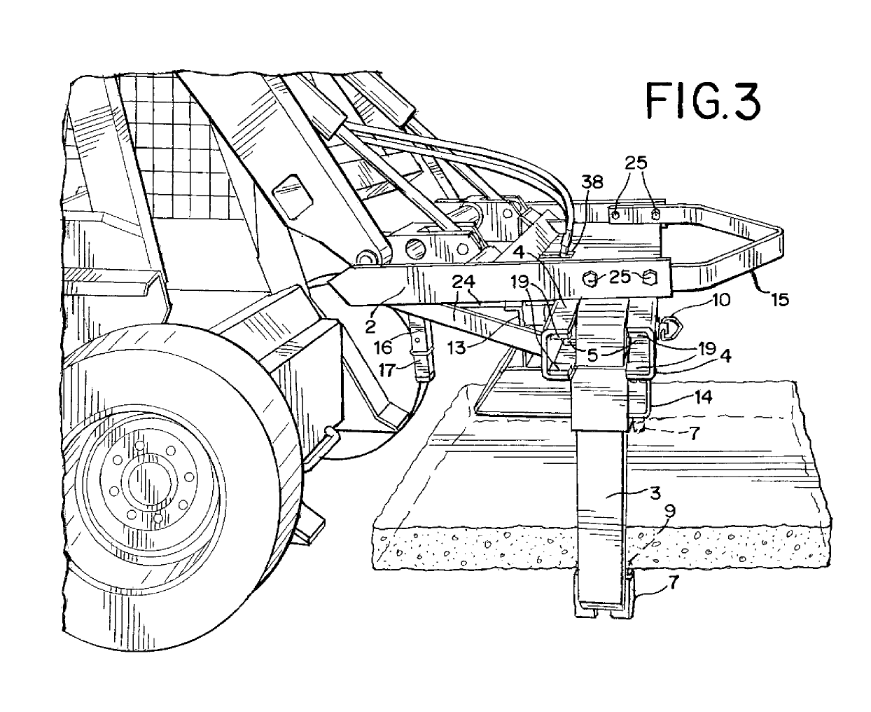

Slabber 1 may include a piston or ram such as hydraulic ram 11 for opening and closing forks 3. Ram 11 may connect to skid steer hydraulics via pressure regulator 12. Turning to FIG. 3, regulator may be disposed within hydraulic pass-through or opening 38 in attaching plate 2. As such, hoses of pressure regulator 12 may be disposed substantially above attaching plate 2, which may reduce or eliminate binding of hoses within slabber. In addition, attaching plate 2 may shield hoses from debris, reducing or eliminating puncturing or other wear to hoses.

Ram 11 may be removably coupled to at least one of, and preferably both, picking forks 3. For example, ram 11 may include a first mounting bracket 78 at one end for connecting to a first fork 4 and a second mounting bracket 80 at an opposite end for connecting to a second fork 4. Brackets 78, 80 may connect ram 11 to a plurality of ram mounts 56 disposed on forks 4, e.g., via pins 23 inserted through openings 58 in mounts and openings in brackets 78, 80.

Hydraulics may be configured to open and close each rail generally equally or at substantially the same time. Preferably, however, pressure regulator 12 may include a hydraulic crossover. Crossover may allow for direct opening of one fork until a limit position is reached. At that point, hydraulic pressure may increase across the crossover, powering the other fork to a desired amount of separation.

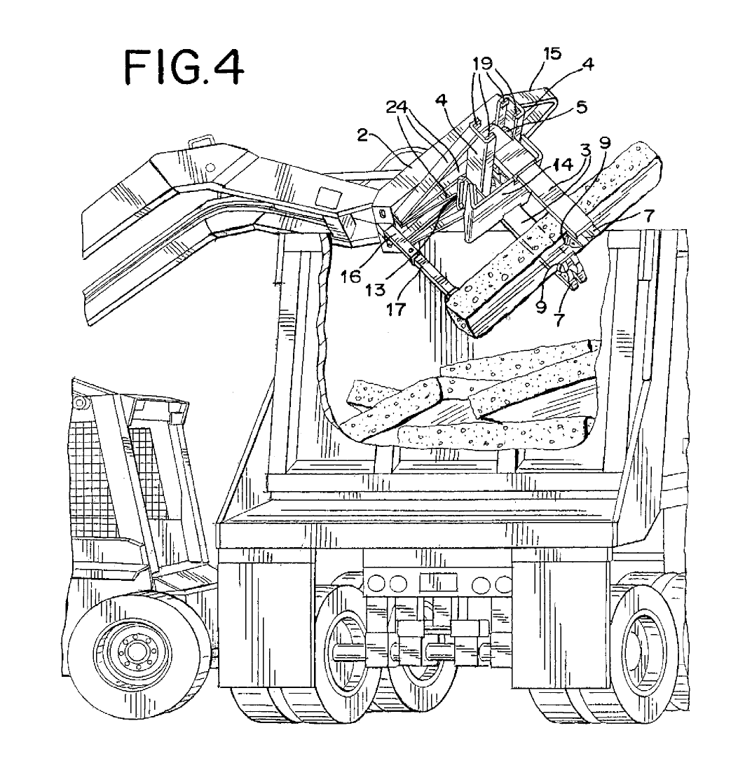

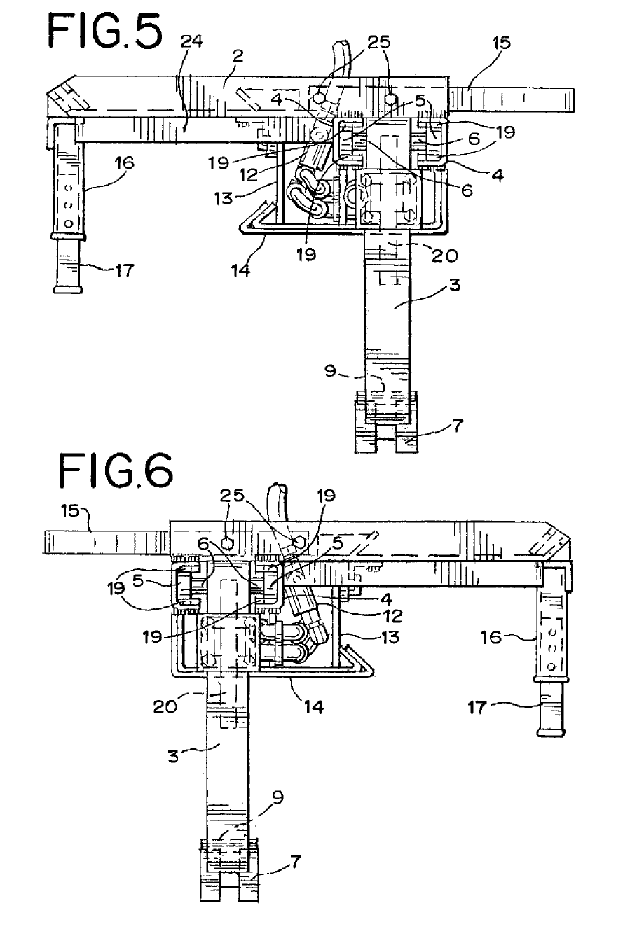

Slabber 1 may include a first cover 13 coupled to a first fork 4 and a second cover 14 coupled to a second fork 4. Covers 13, 14 may be sized to allow one to fit inside the other, permitting lateral movement of covers relative to each other. As seen in FIG. 4, cover 13 may be sized to fit within cover 14, although an opposite configuration also is possible. Covers 13, 14 may combine to shield ram 11 and regulator hoses 12 from potential damage caused by debris, e.g., if slab cracks upward or if forks 3 are lowered too far into ground.

Cover 13 may include a forward plate 102, a rear plate 104, and a lateral plate 106 therebetween. Similarly, cover 14 may include a forward plate 122, a rear plate 124, and a lateral plate 126 therebetween.

Forward plates 102, 122 may extend generally vertically, i.e., generally parallel to rails 4. Rear plates 104, 124 may be angled with respect to rails 4, which, due to overlap between covers 13, 14, may provide support for cover 14 along its length. Cover 13 also may include a hook 108 extending away from forward plate 102, forming gap 110 between forward plate 102 and end of hook 108. A portion of forward plate 122 of second cover 14 may be disposed within gap 110, and gap 110 may be sized slightly larger than a thickness of forward plate 122, so as to permit sliding of second cover 14 relative to first cover 13.

Covers 13, 14 may couple to their respective forks 4 at cover mounts 20. Cover mounts 20 may comprise a plurality of tabs or flanges extending inward from forks 4 proximate ram mounts 56. Preferably, a plurality of cover mounts 20 may extend from each fork 4, e.g., one on each side of ram mount 56. Cover mounts 20 may be disposed beneath openings 58 in ram mounts 56, or between openings 58 and wear bars 9. As such, when covers 13, 14 are coupled to mounts 20, covers 13, 14 may be disposed between ram 11 and sidewalk portion supported by wear bars 9. Cover mounts 20 may overlap with notches 114, 128 on covers 13, 14, respectively. Cover mounts 20 may couple to covers 13, 14 proximate notches 114, 128, e.g., via welding or fastening.

Lower cover 13 may include one or more braces such as brace 112. Brace 112 may abut or be disposed proximate a plurality of support brackets 24 (described below) and reduce fulcrum-type loading on lower cover 13 at connection with cover mounts 20. In addition, support bracket 24 may help maintain a generally constant gap between lateral plate 106 of cover 13 and support brackets 24, protecting ram 11 from crushing or other damage.

As seen in FIG. 3, slabber 1 also may comprise a safety hoop 15 integral with or coupled to a forward end of attachment plate 2. For example, safety hoop 15 and attachment plate 2 each may include a plurality of aligned openings such as openings 130 on hoop 15 and openings 33 on attachment plate 2. Hoop 15 may be coupled to attachment plate 2 with a plurality of connecting fasteners 25 and nuts 26. Hoop 15 may extend outward a greater distance than substantially all sidewalk segments to be lifted so that a bystander may not accidentally be standing on a segment as the operator starts to remove it. Alternatively, as seen in FIG. 3, hoop 15 may extend a distance generally equal to or less than sidewalk segments. In this case, hoop 15 preferably extends far enough beyond forward end of attachment plate that, in the event sidewalk segment tips while being lifted overhead, hoop 15 may prevent the segment from rotating backward and potentially falling on operator.

Staying with FIG. 3, hoop 15 may comprise a generally V-shaped protrusion extending outward from attachment plate. Hoop 15 may take other forms, such as a generally semi-circular arch or a generally U-shaped protrusion having a pair of arms generally parallel to attachment plate 2 with a crossbar generally perpendicular to the arms.

As seen in FIGS. 2 and 4, slabber 1 may include a depth limiter 16 extending downward toward sidewalk segment. For example, limiter 16 may be coupled to attachment plate 2. In one embodiment, limiter 16 may be coupled directly to attachment plate 2. Alternatively, limiter 16 may be coupled to attachment plate 2 via a connector such as bracket 22. Bracket may abut multiple surfaces of limiter 16, which may increase surface contact area or seam length for limiter. In the event that limiter 16 is welded to bracket 22, increased seam length may allow for longer welds and, relatedly, higher attachment strength for limiter. Preferably, limiter may be located in a position easily viewable by the operator. For example, limiter 16 may be centered widthwise on attachment plate 2 and disposed proximate a rearward end of attachment plate 2.

Limiter 16 may slidably couple to a limiter insert 17, e.g., insert 17 may fit inside limiter 16. Insert 17 may include a foot 134 or cap at a distal end, which may prevent debris from compacting inside insert 17 and/or make distal end more easily viewable to the operator. For example, foot 134 may have a wider perimeter than insert 17 and/or be colored differently than insert 17 to provide better visible contrast.

Limiter 16 may include at least one opening 132, and insert 17 may include at least a first plurality of openings 136. To adjust the depth control, insert 17 may be translated a desired amount until one opening of the first plurality of openings 136 is aligned with opening 132, and a pin 18 may be inserted into the aligned openings to maintain the selected depth. In one embodiment, limiter 16 may include a pair of openings 132 on opposite sides of limiter, insert 17 may include a second plurality of openings on an opposite side of the first plurality of openings 136, and pin 18 may have a length configured to pass through all aligned openings.

If the operator knows how deep each sidewalk portion to be removed is, he may preset a depth of the limiter insert 17 prior to removing any segments. Insert 17 may include a scale along one or more of its sides to display a vertical distance between bottom of insert foot 134 and tops of wear bars 9. When the insert displays a distance corresponding to the sidewalk distance or, if no match, the next distance larger than the distance to the sidewalk, the operator may insert pin 18 to set the insert depth.

Alternatively, because sequential sidewalk segments often have substantially the same thickness, the operator may drive forks 3 under a first segment without setting the depth of insert 17. Once wear bars 9 abut an underside of the first segment, the operator or another person may adjust the limiter insert 17 to a proper depth, which then may be used for each successive segment to be removed.

Limiter 16 with insert 17 may serve several purposes. First, it may provide a visual indicator of the depth to which the operator needs to drive forks 3 into the ground alongside the sidewalk segments. This may lead to a more efficient removal process, as less time is spent driving forks unnecessarily deep. In addition, by controlling the depth of fork embedment, it may help minimize disturbance of the soil surrounding and underneath the sidewalk segment. Moreover, insert 17 may serve as a stop to prevent any inadvertent rotation of the segment in one direction, which may lead to the segment being more securely transported.

Turning to FIGS. 2 and 4, slabber 1 may include a plurality of brackets 24 for supporting one or more of rails 4 and/or attachment plate 2. Brackets 24 may comprise a plurality of fingers 138. Each finger 138 may extend along underside of attachment plate 2, and each finger 138 may be coupled to rails 4 and/or attachment plate 2, e.g., via welds. As seen in FIG. 4, each bracket 24 may include a fan-like array of fingers 138, each finger 138 extending from a central point proximate a rear end of attachment plate toward one or more of rails 4. Fingers 138 each may originate from a common point. Alternatively, slabber 1 may include a plurality of brackets 24 disposed in a side-by-side arrangement across a width of attachment plate. Angles between fingers 138 may be substantially equal, attaching to rail 4 at substantially equal intervals along a length of rail 4.

Staying with FIG. 4, one or more of fingers 138 may be coupled to attachment plate 2. As such, fingers 138 may provide additional rigidity to attachment plate 2 while also helping to distribute weight of slabber 1 and sidewalk section across attachment plate 2.

As seen in FIGS. 1 and 3, slabber 1 may be connected to skid steer 90 or other equipment so that attachment plate 2 is generally parallel to the ground and forks 3 extend generally downward toward ground when skid steer 90 is in a dumping configuration, i.e., where end arm of skid steer 90 is generally horizontal/level with ground. Once the sidewalk segment is removed from the ground, the skid steer end arm may be retracted, rotating slabber 1 and the sidewalk segment upward. This configuration may allow the slabber 1 and segment to be lifted higher off the ground than when in the dumping configuration. Higher clearance may be beneficial when lifting slabber and segment, such as when loading segment into a bin hauled by a semi truck. As seen in FIG. 4, once the slabber 1 and segment clear the upper edge of the bin, slabber 1 may be rotated back to the dumping position, which may decrease the distance the segment falls when released. In addition, it may cause the segment to be more level when released, which may reduce the occurrence of cracked and/or broken segments.

Slabber 1 may be used to remove a sequence of sidewalk segments while causing minimal damage to the area surrounding the sidewalk. Preferably, segments may be saw-cut into predetermined lengths or ranges of length, e.g., by cutting along seams between segments or by cutting every about 4 to about 6 feet. The slabber 1 may be maneuvered onto the sidewalk without driving over the parkway or other landscaped area. For example, skid steer 90 with attached slabber 1 may travel up a driveway, street, or other path until it intersects with the sidewalk. Skid steer 90 then may travel along sidewalk until reaching the section of sidewalk to be removed. Preferably, skid steer may travel to the farthest segment first.

After segment is cut to separate it from its adjoining segments, slabber 1 may be disposed over segment. Forks 3 may be translated along rails 4 until spacing between forks 3 is substantially equal to segment width and then lowered into the ground. If segment depth is known and depth limiter previously was set according to segment depth, forks 3 may be lowered until limiter insert 17 contacts the segment or is slightly above segment. In either case, once forks 3 are driven to a depth that allows wear bars 9 to be disposed underneath the segment, forks 3 may be drawn together to partially clasp segment between forks. Slabber 1 may be raised and lowered one or more times to break vacuum pressure between segment and underlying ground. Whether this step is done or not, forks 3 then may be drawn even more closely together so that the underside of the sidewalk segment rests on wear bars 9 and forks 3 provide a compressive force to the sides of the segment.

Once gripped, slabber 1 and segment may be raised substantially vertically until the segment and wear bar holder 7 are clear of the newly-formed hole. Skid steer then may be turned around or reversed down the sidewalk to the driveway and driven to a location for dumping the removed segment. Alternatively, depending on the distance between the sidewalk and a street curb, a dump truck, semi truck with dumping bin, flatbed truck, or other vehicle may be positioned alongside the curb. Once the segment is removed, the skid steer may be turned to face the truck. Slabber 1 may be raised to clear an upper edge of the vehicle's storage area, which may include rotating the end arm of the skid steer and the attached slabber upward. Once cleared, slabber 1 may be rotated back to the initial dumping configuration. In either event, to release the sidewalk segment, forks 3 may be widened, releasing their grip on the segment.

Once the segment is deposited, skid steer 90 may return to the sidewalk and remove the next closest segment. In this way, skid steer 90 with slabber 1 may move from segment to segment while travelling along existing sidewalk, eliminating the need to travel on the surrounding parkway or landscaping or from driving into and disturbing the hole formed by removed segments. Removing each segment may result in leaving a hole substantially the same size as the segment and a plurality of small holes corresponding to the number of forks 3. In this case, preparing the area for a new section of sidewalk may be simplified greatly, as the only landscaping that may be required may be to fill the small holes formed by the forks 3.

As discussed above, slabber 1 may allow a user to remove sidewalk segments while keeping those segments substantially intact. As such, sidewalk segments may be loaded into a bin or truck bed, e.g., and transported intact to another site. At that second location, slabber 1 or additional equipment may be used to lift slabs and use them for another purpose. For example, removed sidewalk segments may be used to form a new sidewalk path. Other exemplary uses for sidewalk segments may include forming retaining walls or installing segments as part of a system for erosion control.

While the foregoing written description of the invention enables one of ordinary skill to make and use what is considered presently to be the best mode thereof, those of ordinary skill will understand and appreciate the existence of variations, combinations, and equivalents of the specific exemplary embodiments and methods herein. The invention should therefore not be limited by the above described embodiments and methods, but by all embodiments and methods within the scope and spirit of the invention as claimed.

What is claimed is:

1. An apparatus for removing a sidewalk segment, comprising:
a base portion including a plurality of rails;
a plurality of forks translatable along said plurality of rails, each of said forks having a distal end;
a hydraulic system controlling translation of said forks; and
a plurality of bearing surfaces proximate said distal ends of respective ones of said plurality of forks;
wherein said plurality of forks extend substantially downward when inserted into ground surrounding said sidewalk segment; and
wherein said plurality of bearing surfaces are substantially perpendicular to said plurality of forks.

2. An apparatus according to claim 1,
said base portion including a flange and a bearing plate configured to releasably couple said apparatus to a skid steer.

3. An apparatus according to claim 1,
wherein said distal end of each of said forks tapers.

4. An apparatus according to claim 1,
wherein said plurality of bearing surfaces are releasably coupled to said plurality of forks.

5. An apparatus according to claim 1, further comprising:
a plurality of holders proximate said distal ends of respective ones of said plurality of forks, said plurality of holders configured to hold a plurality of wear bars, wherein said plurality of wear bars comprise said plurality of bearing surfaces.

6. An apparatus according to claim 5,
said wear bars including at least one prong and said holders including at least one recess configured to receive said at least one prong.

7. An apparatus according to claim 5,
wherein said distal end of each of said forks tapers;
and further wherein each of said plurality of holders tapers in an opposite direction as said fork tapers.

8. An attachment for a skid steer, comprising:
an attachment plate configured to couple to said skid steer;
a plurality of rails coupled to said attachment plate;
a plurality of forks coupled to a plurality of wheels, wherein said plurality of wheels translate along said plurality of rails;
a plurality of bearing surfaces proximate distal ends of respective ones of said plurality of forks; and
at least one tapered tine proximate a distal end of each of said plurality of forks.

9. An attachment for a skid steer according to claim 8, further comprising:
an adjustable depth limiter.

10. An attachment for a skid steer according to claim 8, further comprising:
a hydraulic system coupled to said plurality of forks, wherein said hydraulic system controls translation of said plurality of forks.

11. An attachment for a skid steer according to claim 10,
wherein said plurality of forks comprises two forks;
and further wherein said hydraulic system includes a main line and a crossover line, said main line controlling translation of one of said two forks, and said crossover line controlling translation of a second of said two forks.

12. An attachment for a skid steer according to claim 10, further comprising:
a first cover coupled to one fork between said distal end of said one fork and said hydraulic system; and
a second cover coupled to a second fork between said distal end of said second fork and said hydraulic system;
wherein said first cover and said second cover overlap.

13. An attachment for a skid steer according to claim 8,
wherein said plurality of bearing surfaces are removably coupled to said attachment.

14. An attachment for a skid steer according to claim 8,
wherein said plurality of rails include a plurality of inwardly-extending stops configured to limit translation of said plurality of wheels.

15. An apparatus for removing a sidewalk segment, comprising:
a plurality of translatable forks, each fork including a proximal end and a tapered, distal end;
a plurality of wear bars, each wear bar having a bearing surface, each surface substantially perpendicular to a respective fork;
a plurality of wear bar holders proximate said distal ends of said respective forks; and
a hydraulic ram coupled to at least one of said forks;
wherein at least one wear bar includes a prong and at least one wear bar holder includes a recess configured to receive said prong.

16. An apparatus according to claim 15,
wherein at least one wear bar holder includes at least one tine extending below said distal end of said fork.

17. An apparatus according to claim 16,
wherein said tine tapers from proximate said bearing surface toward a distal end of said tine.

18. An apparatus according to claim 15, further comprising:
a plurality of wheels coupled to said plurality of forks proximate said proximal end; and
a plurality of rails configured to receive said plurality of wheels, wherein at least one rail includes a stop extending inward, said stop configured to restrain translation of at least one of said forks.

19. An apparatus according to claim 18, further comprising:
a removable pin;
wherein said plurality of rails include a plurality of openings configured to receive said pin;
and wherein said pin is configured to restrain translation of at least one of said forks and further is configured to resist deformation caused by forces applied by said at least one of said forks.

20. An apparatus according to claim 15, further comprising:
a base portion configured to support said plurality of forks, said plurality of wear bars, said plurality of wear bar holders, and said hydraulic ram;
wherein said base portion further is configured to translate in a direction substantially perpendicular to said sidewalk segment and to rotate about an axis substantially parallel to said sidewalk segment.
